(19) United States
(12) Patent Application Publication
(10) Pub. No.: US 2026/0120433 A1
(43) Pub. Date: Apr. 30, 2026

(54) MULTIMODAL LANGUAGE PROCESSING DEVICE AND METHOD BASED ON VISION-LANGUAGE MODEL

(71) Applicant: UIF (UNIVERSITY INDUSTRY FOUNDATION), YONSEI UNIVERSITY, Seoul (KR)

(72) Inventor: Youngjae Yu, Seoul (KR)

(73) Assignee: UIF (UNIVERSITY INDUSTRY FOUNDATION), YONSEI UNIVERSITY, Seoul (KR)

(21) Appl. No.: 18/934,117

(22) Filed: Oct. 31, 2024

(30) Foreign Application Priority Data
Oct. 25, 2024 (KR) 10-2024-0147826

(51) Int. Cl. G06V 10/70; G06F 40/284

(52) U.S. Cl. CPC G06V 10/768; G06F 40/284

(57) ABSTRACT

The present invention relates to a multimodal language device based on a visual-language model and includes a response generation unit that receives a question including an image and text through a text-only language model and a vision-language model, and generates a text response and a multimodal response, a PMI calculation unit that calculates pointwise mutual information (PMI) representing a correlation between the image and the text based on the multimodal response, and an importance sampling unit that generates an importance weight based on the pointwise mutual information and adjusts a token likelihood of the text response based on the importance weight to generate a final text response.

### CROSS-REFERENCE TO RELATED APPLICATION

This application claims under 35 U.S.C. § 119(a) the benefit of Korean Patent Application No. 10-2024-0147826 filed on Oct. 25, 2024, the entire contents of which are incorporated herein by reference.

### TECHNICAL FIELD

The present invention relates to a multimodal language processing technology based on a visual-language model, and more specifically, to a multimodal language processing device and method based on a visual-language model capable of receiving a question including an image and text through a text-only language model and a vision-language model and generating a text response and a multimodal response to the question.

### BACKGROUND

Vision-language model (VLM) technology is an artificial intelligence model capable of simultaneously processing an image (visual information) and text (linguistic information), and analyzes a given image and processes text data related to the image so that the two pieces of information can be utilized together.

The visual-language model (VLM) technology may be applied to image captioning for automatically generating explanation of an image, visual question answering (VQA) for answering a question related to an image by viewing the image, and image-text matching for finding an image according to text or generating the explanation of the image.

Korean Patent Publication No. 10-2022-0176260 (Dec. 15, 2022) includes a step of selecting, by a learning device, a pair of image and text from learning data, inputting the image to an image encoder, and inputting the text to a text encoder, a step of performing, by the learning device, image-text contrastive learning (ITC) for the image encoder and the text encoder, a step of performing, the learning device, masked image modeling (MIM) for a first cross-modal encoder that receives an image embedding output by the image encoder, a step of performing, by the learning device, masked language modeling (MLM) for a second cross-modal encoder that receives a text embedding output by the text encoder, and a step of performing, by the learning device, image-text matching (ITM) learning for the image embedding output by the first cross-modal encoder and the text embedding output by the second cross-modal encoder

### PRIOR ART LITERATURE

### Patent Literature

Korean Patent Publication No. 10-2022-0176260 (Dec. 15, 2022)

### DESCRIPTION

### Problem to be Solved

An embodiment of the present invention provides a multimodal language processing device and method based on a visual-language model capable of receiving a question including an image and text through a text-only language model and a vision-language model and generating a text response and a multimodal response to the question.

An embodiment of the present invention provides a multimodal language processing device and method based on a visual-language model capable of calculating the pointwise mutual information (PMI) indicating a correlation between an image and text based on a multimodal response.

An embodiment of the present invention provides a multimodal language processing device and method based on a visual-language model capable of generating an importance weight based on the pointwise mutual information and adjusting a token likelihood of a text response based on the importance weight to generate a final text response.

### Solution

In embodiments, a multimodal language processing device based on a visual-language model includes a response generation unit configured to receive a question including an image and text through a text-only language model and a vision-language model, and generate a text response and a multimodal response; a PMI calculation unit configured to calculate pointwise mutual information (PMI) representing a correlation between the image and the text based on the multimodal response; and an importance sampling unit configured to generate an importance weight based on the pointwise mutual information and adjust a token likelihood of the text response based on the importance weight to generate a final text response.

The response generation unit may reflect a context of the image in the text through the vision-language model to generate the multimodal response.

The PMI calculation unit may calculate mutual dependency between the image and the text as the pointwise mutual information to determine token importance of the text in the context of the image.

The PMI calculation unit may calculate the mutual dependency as the pointwise mutual information based on a probability that a specific text will be generated when the image and a token of the text are given and a probability that the token of the text will be generated in a text context before the token of the text when only the text is given.

The importance sampling unit may multiply the token likelihood of the text response by the importance weight to select an important token from the text response.

The importance sampling unit may select the important token and reflect the visual context of the image in the final text response.

In embodiments, a visual-language model-based multimodal language processing method performed in a multimodal language processing device based on a visual-language model includes a response generation step of receiving a question including an image and text through a text-only language model and a vision-language model and generating a text response and a multimodal response to the question; a PMI calculation step of calculating pointwise mutual information (PMI) representing a correlation between the image and the text based on the multimodal response; and an importance sampling step of generating an importance weight based on the pointwise mutual information and adjusting a token likelihood of the text response based on the importance weight to generate a final text response.

The response generation step may include reflecting a context of the image in the text through the vision-language model to generate the multimodal response.

The PMI calculation step may include calculating mutual dependency between the image and the text as the pointwise mutual information to determine token importance of the text in the context of the image.

The PMI calculation unit may calculate the mutual dependency as the pointwise mutual information based on a probability that a specific text will be generated when the image and a token of the text are given and a probability that the token of the text will be generated in a text context before the token of the text when only the text is given.

The importance sampling step may include multiplying the token likelihood of the text response by the importance weight to select an important token from the text response.

The importance sampling step may further include selecting the important token and reflects the visual context of the image in the final text response.

The disclosed technology can have the following effects. However, since this does not mean that a specific embodiment should include all of the following effects or only the following effects, the scope of the disclosed technology should not be understood as being limited thereby.

According to the multimodal language processing device and method based on a visual-language model according to an embodiment of the present invention, it is possible to receive the question including an image and text through the text-only language model and the vision-language model, and generate the text response and the multimodal response to the question.

According to the multimodal language processing device and method based on a visual-language model according to an embodiment of the present invention, it is possible to calculate the pointwise mutual information (PMI) representing the correlation between the image and the text based on the multimodal response.

According to the multimodal language processing device and method based on a visual-language model according to an embodiment of the present invention, it is possible to generate the importance weight based on the pointwise mutual information and adjust the token likelihood of the text response based on the importance weight to generate the final text response.

### BRIEF DESCRIPTION OF THE DRAWINGS

FIG. 1 is a diagram illustrating a multimodal language processing device based on a visual-language model according to an embodiment of the present invention.

FIG. 2 is a diagram illustrating a functional configuration of the multimodal language processing device based on a visual-language model of FIG. 1.

FIG. 3 is a diagram illustrating a system configuration of the multimodal language processing device based on a visual-language model of FIG. 1.

FIG. 4 is a flowchart illustrating a multimodal language processing method based on a visual-language model according to the present invention.

FIG. 5 is a qualitative sample from a WHOOPS (Bitton Guetta et al., 2023) experiment.

FIG. 6 is generation results in an OK-VQA dataset (Marino et al., 2019).

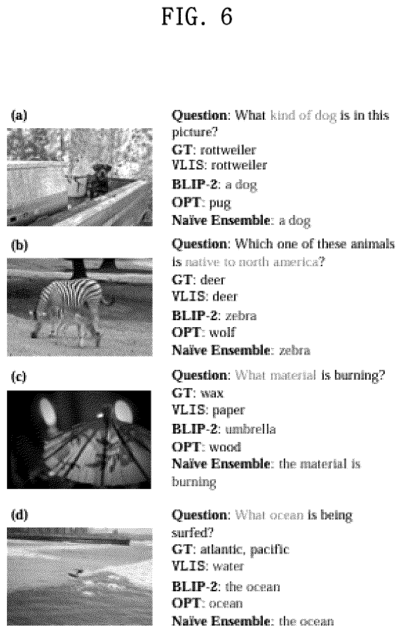

### DETAILED DESCRIPTION

A description of the present disclosure is merely an embodiment for a structural or functional description and the scope of the present disclosure should not be construed as being limited by an embodiment described in a text. That is, since the embodiment can be variously changed and have various forms, the scope of the present disclosure should be understood to include equivalents capable of realizing the technical spirit. Further, it should be understood that since a specific embodiment should include all objects or effects or include only the effect, the scope of the present disclosure is limited by the object or effect.

Meanwhile, meanings of terms described in the present application should be understood as follows.

The terms “first,” “second,” and the like are used to differentiate a certain component from other components, but the scope of should not be construed to be limited by the terms. For example, a first component may be referred to as a second component, and similarly, the second component may be referred to as the first component.

It should be understood that, when it is described that a component is “connected to” another component, the component may be directly connected to another component or a third component may be present therebetween. In contrast, it should be understood that, when it is described that an element is “directly connected to” another element, it is understood that no element is present between the element and another element. Meanwhile, other expressions describing the relationship of the components, that is, expressions such as “between” and “directly between” or “adjacent to” and “directly adjacent to” should be similarly interpreted.

It is to be understood that the singular expression encompasses a plurality of expressions unless the context clearly dictates otherwise and it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

In each step, reference numerals (e.g., a, b, c, etc.) are used for convenience of description, the reference numerals are not used to describe the order of the steps and unless otherwise stated, it may occur differently from the order specified. That is, the respective steps may be performed similarly to the specified order, performed substantially simultaneously, and performed in an opposite order.

The present disclosure can be implemented as a computer-readable code on a computer-readable recording medium and the computer-readable recording medium includes all types of recording devices for storing data that can be read by a computer system. Examples of the computer readable recording medium may include a ROM, a RAM, a CD-ROM, a magnetic tape, a floppy disk, an optical data storage device, and the like. Further, the computer readable recording media may be stored and executed as codes which may be distributed in the computer system connected through a network and read by a computer in a distribution method.

If it is not contrarily defined, all terms used herein have the same meanings as those generally understood by those skilled in the art. Terms which are defined in a generally used dictionary should be interpreted to have the same meanings as the meanings in the context of the related art, and are not interpreted as ideal meanings or excessively formal meanings unless clearly defined in the present application.

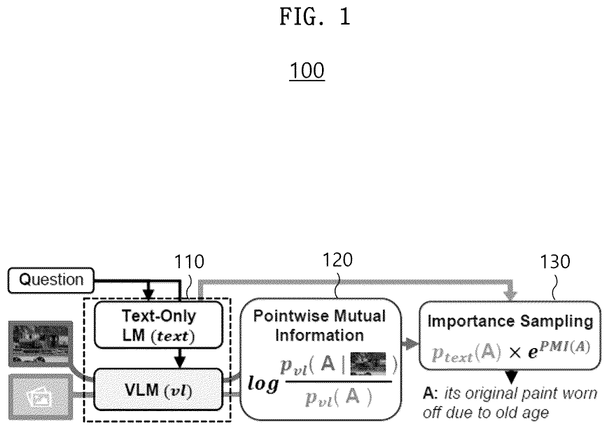

FIG. 1 is a diagram illustrating a multimodal language processing device based on a visual-language model according to an embodiment of the present invention.

Referring to FIG. 1, a multimodal language processing device based on a visual-language model 100 may include a response generation unit 110, a pointwise mutual information (PMI) calculation unit 120, and an importance sampling unit 130.

The response generation unit 110 may receive a question including an image and text through the text-only language model and the vision-language model, and generate a text response and a multimodal response to the question. In an embodiment, the response generation unit 110 may reflect the context of an image into text through a vision-language model to generate the multimodal response.

More specifically, an operation of the response generation unit 110 is as follows.

The response generation unit 110 inputs image data provided by the user for an image input to the vision-language model (VLM) in an input processing process, and inputs question text provided with the image for a text input to both the text-only language model and the vision-language model.

The text-only language model understands a linguistic context based on a given text question for text response generation and generates a text-based response to the question. For example, the text-only language model does not use visual information and may derive an answer based on a meaning and context of the text itself. More specifically, the text-only language model may attempt to answer the question, “What is the color of this car?” with only the text context without the visual information.

The vision-language model may process the image and the text question together to analyze a correlation between the visual information and the text for multimodal response generation, and generate a more specific and visually relevant response to the question based on information on objects or scenes in the image. For example, the vision-language model may generate the answer, “green,” confirmed in the image for the question, “What is the color of this car?”

The response generation unit 110 may compare or integrate the text response generated by the text-only model with the multimodal response generated by the vision-language model in a response integration and selection process to determine a final response. In this process, the response generation unit 110 may select the multimodal response when the visual information is more important, and select the response of the text-only model when the visual information is not necessary.

The response generation unit 110 may output a finally selected response (the text response or the multimodal response) to the user in a final response output process, which may vary depending on the nature of the question and the importance of given visual information. In conclusion, the response generation unit 110 may generate text and multimodal responses to the question of the user by utilizing both the text-only language model and the vision-language model, and integrate these to provide a more accurate and relevant answer according to the nature of the question through an important role in determining the final response.

The PMI calculation unit 120 may calculate a mutual dependency between the image and the text as the pointwise mutual information to determine the token importance of the text in the context of the image. In an embodiment, the PMI calculation unit 120 may calculate the mutual dependency as the pointwise mutual information based on the probability that a specific text will be generated when tokens of the image and the text are given and the probability that the token of the text will be generated in a text context preceding the token of the text when only the text is given.

More specifically, an operation of the PMI calculation unit 120 is as follows.

A multimodal language processing device based on a visual-language model 100 can receive an image and text input by a user.

The PMI calculation unit 120 may calculate probabilities P(x)P(x)P(x) and P(y)P(y)P(y) that a given image and text will be generated separately.

The PMI calculation unit 120 may calculate a probability P(x,y)P(x,y)P(x,y) that the given image and text will be generated together.

The PMI calculation unit 120 may substitute this value into a formula to calculate a PMI value, and measure the correlation between the image and the text.

In conclusion, the PMI calculation unit 120 plays an important role in quantitatively evaluating he correlation between the image and the text in a multimodal system, thereby improving the response accuracy of the system.

The importance sampling unit 130 may multiply a token likelihood of the text response by an importance weight to select an important token from a text response. In an embodiment, the importance sampling unit 130 may select the important token to reflect a visual context of the image in the final text response.

More specifically, an operation of the importance sampling unit 130 is as follows.

The importance sampling unit 130 may generate an importance weight based on mutual information for each point, adjust the token likelihood of the text response according to the generated importance weight, generate a final text response based on the adjusted token likelihood, automatically process a process of adjusting the weight and the token, and enhance the reflection of important elements in a text generation process to generate a text response more precisely in the system.

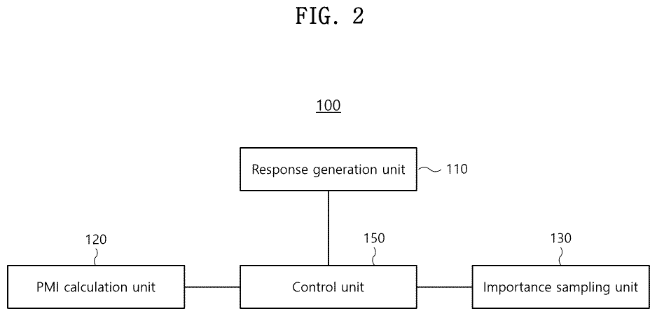

FIG. 2 is a diagram illustrating a functional configuration of the multimodal language processing device based on a visual-language model of FIG. 1.

The response generation unit 110 may receive a question including an image and text through the text-only language model and the vision-language model to generate a text response and a multimodal response to the question. In an embodiment, the response generation unit 110 reflects the context of the image in the text through the vision-language model to generate the multimodal response.

More specifically, the response generation unit 110 may analyze the context of the image using the vision-language model, reflect information obtained from the image in the text response, combine the text with the image information to generate a multimodal response based on a harmony between the image and the text, and reflect various input forms to generate a comprehensive response in which the image and the text are considered together by providing a richer response.

The PMI calculation unit 120 may calculate the mutual dependency between the image and the text as the pointwise mutual information to determine the token importance of the text in the context of the image. In an embodiment, the PMI calculation unit 120 may calculate the mutual dependency as the pointwise mutual information based on the probability that the specific text will be generated when tokens of the image and the text are given and the probability that the token of the text will be generated in a text context preceding the token of the text when only the text is given.

More specifically, the PMI calculation unit 120 may calculate the mutual dependency between the image and the text calculated through the pointwise mutual information, determines the token importance of the text in consideration of the context of the image, and adjust the importance of each token of the text according to the context of the image through a determination of information importance based on the correlation between the image and the text, thereby more accurately reflecting the relationship between the image and the text.

Further, the PMI calculation unit 120 may calculate the probability that the specific text will be generated when an image and text are given, analyzes the probability that a token will be generated in a context of the text when only text is given, compares the two probabilities to calculate mutual information, and quantifies a correlation between the image and the text using pointwise mutual information, thereby accurately calculating mutual dependency between the text and the image through reflecting an influence of the image in text generation.

The importance sampling unit 130 may multiply the token likelihood of the text response by the importance weight to select the important token from the text response. In an embodiment, the importance sampling unit 130 may select the important token to reflect the visual context of the image in the final text response.

More specifically, the importance sampling unit 130 can emphasize a core token in the text response through a process of selecting tokens with high importance after the weight is applied, and better reflect core information of the response using the importance weight through final response generation based on the important token.

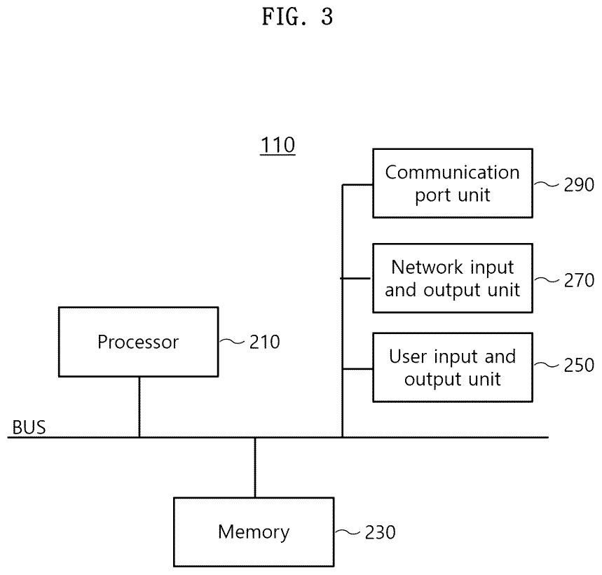

FIG. 3 is a diagram illustrating a system configuration of the multimodal language processing device based on a visual-language model of FIG. 1.

Referring to FIG. 3, the multimodal language processing device based on the visual-language model 100 may include a processor 210, a memory 230, a user input and output unit 250, a network input and output unit 270, and a communication port unit 290.

The processor 210 may receive a question including a video and text through a text-only language model and a vision-language model, generate a text response and a multimodal response to the question, manage the memory 230 that is read or written in such a process, and schedule a synchronization time between a volatile memory and a nonvolatile memory in the memory 230. The processor 210 may control an overall operation of the multimodal language processing device based on a visual-language model 100, and may be electrically connected to the memory 230, the user input and output unit 250, the network input and output unit 270, and the communication port unit 290 to control data flows between these units. The processor 210 may be implemented as a central processing unit (CPU) or a graphics processing unit (GPU) of the multimodal language processing device based on a visual-language model 100.

The memory 230 may include an auxiliary memory device implemented as a non-volatile memory such as a solid state disk (SSD) or a hard disk drive (HDD) and used to store all of data required for the multimodal language processing device based on a visual-language model 100, and may include a main memory device implemented as a volatile memory such as a random access memory (RAM). Further, the memory 230 may store a set of instructions that execute a role of the multimodal language processing device based on a visual-language model 100 according to the present disclosure by being executed by the electrically connected processor 210.

The user input and output unit 250 may include an environment for receiving a user input and an environment for outputting specific information to a user, and may include, for example, an input device including an adapter such as a touch pad, a touch screen, a visual keyboard, or a pointing device, and an output device including an adapter such as a monitor or a touch screen. In an embodiment, the user input and output unit 250 may correspond to a computing device connected via a remote connection, and in such a case, the multimodal language processing device based on a visual-language model 100 may function as an independent server.

The network input and output unit 270 may provide a communication environment for connection to an attack IP terminal or a test IP terminal through a network, and may include, for example, an adapter for communication such as a local area network (LAN), a metropolitan area network (MAN), a wide area network (WAN), and a value added network (VAN). Further, the network input and output unit 270 may be implemented to provide a short-distance communication function such as WiFi or Bluetooth or a wireless communication function of 4G or higher for wireless transmission of data.

The communication port unit 290 is a hardware interface for connection to external hardware, and for example, the external hardware may include a printer, a mouse, and USB hardware. The communication port unit 290 may detect a connection of specific USB hardware and perform a role of a CTI enhancement device 130.

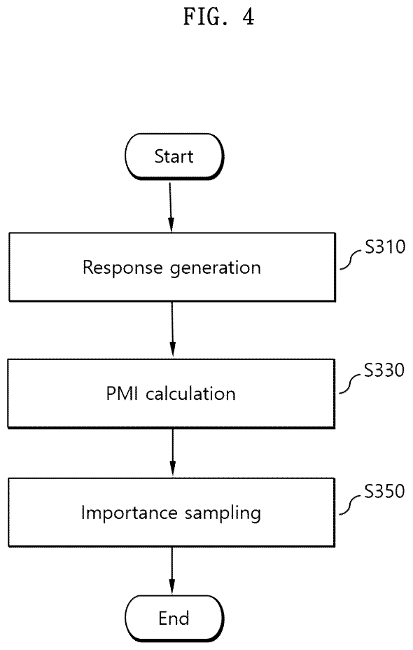

FIG. 4 is a flowchart illustrating a multimodal language processing method based on a visual-language model according to the present invention.

In FIG. 4, a multimodal language processing device based on a visual-language model 100 performs a response generation step of receiving a question including an image and text through a text-only language model and a vision-language model and generating a text response and a multimodal response to the question (step S310), a PMI calculation step of calculating pointwise mutual information (PMI) representing a correlation between the image and the text based on the multimodal response (step S330), and an importance sampling step of generating an importance weight based on the pointwise mutual information and adjusting a token likelihood of the text response based on the importance weight to generate a final text response (step S350).

In step S310, the response generation unit 110 may reflect the context of the image into the text through the vision-language model to generate a multimodal response.

More specifically, the response generation unit 110 may provide various responses in consideration of both text and images through a process in which the text-only language model and the vision-language model receive a question including an image and text, the text-only model generates a text response, the vision-language model generates a multimodal response that is a combination of an image with text to generate a final response based on text and image information in which the two models collaborate.

A process of the response generation step (step S310) is as follows.

The multimodal language processing device based on a visual-language model 100 may collect questions including images and texts input by a user for input collection. For example, the multimodal language processing device based on a visual-language model 100 may receive a question such as “What kind of dog is in this picture?” and the picture.

The text-only language model may generate a response using only the question text, do not process visual information, and derive an answer based on a given text context. For example, the text-only language model may generate a general response such as “Pug” or “Labrador” to a question “What is a dog?”

The vision-language model (VLM) may process input images and texts together to generate a multimodal response that has reflected the visual context. For example, the vision-language model may analyze the image based on the question and the image to generate a more specific and visually relevant response, such as “This dog is a Rottweiler.”

The response generation unit 110 combines a response generated through the text-only language model and the vision-language model to generate the text response and the multimodal response. In this step, the multimodal response reflecting visual information can provide a more accurate response.

In step S330, the PMI calculation unit 120 may calculate the mutual dependency between the image and the text as the pointwise mutual information to determine the token importance of the text in the context of the image. The PMI calculation unit 120 can further include a step of calculating the mutual dependency as the pointwise mutual information based on the probability that the specific text will be generated when tokens of the image and the text are given and the probability that the token of the text will be generated in a text context preceding the token of the text when only the text is given.

More specifically, the PMI calculation unit 120 may analyze the correlation between the image and the text based on the multimodal response, and quantify the correlation between the image and the text using the pointwise mutual information (PMI) to calculate the PMI value indicating how strongly the image and the text are associated with each other for each combination of the image and the text.

A process of the PMI calculation step (step S330) is as follows.

The multimodal language processing device based on a visual-language model 100 may receive an image and a text. For example, the multimodal language processing device based on a visual-language model 100 receives a question “What is the person in this picture doing?” and a corresponding image.

The PMI calculation unit 120 may calculate a probability that the text token xt will be generated when there is a given image c extracted from the vision-language model (VLM) which is an image conditional text likelihood pvl(xt|c) for conditional likelihood calculation. For example, when the given image is a photo including a person, the PMI calculation unit 120 may select tokens such as “person” or “walking” with a higher probability.

The PMI calculation unit 120 may represent a probability that the text token xt will generally appear through the calculation of the probability that the text token xt will be generated without an image which is a marginal probability pvl(xt) of the text token for a marginal probability calculation.

The PMI calculation unit 120 the pointwise mutual information may calculate the PMI, which is an index for evaluating a likelihood that the specific text token will appear when there is the given image, as follows.

$$PMI ( {x}_{t} , c ) = log \frac{{p}_{vl} ( {x}_{t} \vert c )}{{p}_{vl} ( {x}_{t} )}$$

From the perspective of interpretation, the formula can mean that, when a result value is greater, the text token is closely related to the given image. For example, when there is a dog in the image, a PMI value of a word “dog” may be great.

The PMI calculation unit 120 may adjust the response of the text-only model according to the visual information using the calculated PMI value. In this process, the PMI calculation unit 120 can increase the token importance that has reflected the visual context to improve the accuracy of the final response.

In step S450, the importance sampling unit 130 may multiply the token likelihood of the text response by the importance weight to select the important token from the text response, and may select the important token to reflect the visual context of the image in the final text response.

More specifically, the importance sampling unit 130 may generate the importance weight by utilizing the pointwise mutual information (PMI), adjust the probability of each token according to the importance weights, and generate a final text response based on the adjusted token likelihood, thereby providing a response in which the key token is emphasized.

A process of the importance sampling step (step S350) is as follows.

The importance sampling unit 130 may evaluate the correlation with the image for each text token based on the PMI value calculated in the previous step for generation of the importance weight based on the PMI. The importance sampling unit 130 may calculate the importance weight of each token, which is a value reflecting the token importance in a text response generation process, based on the PMI value.

$$Importance Weight = ePMI ( xt , c )$$

From the perspective of interpretation, the formula may indicate that the text token is more closely associated with the image when the importance weight is highest.

The text-only model may calculate the probability that each token xtx_txt will be generated next, based only on the text context for adjustment of the token likelihood of the text response. ptext(xt|x<t)

The importance sampling unit 130 may multiply the token likelihood calculated in the text-only model by the importance weight to adjust the final token likelihood that has reflected the visual context.

$$pfinal ( xt \vert x < t , c ) = ptext ( xt \vert x < t ) \times ePMI ( xt , c )$$

From the perspective of interpretation, a token with a high correlation with the image has a higher importance weight, which may increase the possibility of selecting the token.

The importance sampling unit 130 may generate a text response based on the final token likelihood that has reflected the importance weight for generation of the final text response. The importance sampling unit 130 may reflect both the visual context and the linguistic context by linking finally selected tokens to form the final text response.

### 1. VLM as Importance Sampling Weight

In order to harmonize a visual conditioning function of the VLM with linguistic fluency of the text-only language model, a visual language model is proposed as an importance sampling weight (VLIS). The intuition of the approach is provided in Section 1.1, a token-level visual alignment score is explained in Section 1.2, and the score is combined with the text-only model through importance sampling in Section 1.3.

### 1.1 Intuition

Many recent vision-language models (VLMs) (Li et al., 2023b; Alayrac et al., 2022; Liu et al., 2023) are often constructed based on text-only language models (Iyer et al., 2022; Hoffmann et al., 2022; Touvron et al., 2023). In each time step t, a token-wise likelihood of an autoregressive text-only language model is modeled as ptext(xt|x<t), where x represents a text token. To construct VLM pvl, the text-only model can be fine-tuned with the goal of maximum likelihood estimation on data S including the image c and text x.

$${θ}_{υ l} ∼ arg {min}_{θ} {E}_{( x , c ) ∈ S} [ - log {p}_{θ} ( x \vert c ) ] \qquad ( 1 )$$

However, this goal only maximizes the probability pvl(xt|c) conditioned on images, and may lead to unexpected results in the marginal probability pvl(xt) that does not depend on a specific image. For example, an image captioning model is known to reflect and amplify social bias present in training data (Hendricks et al., 2018), and may distort commonsense knowledge of an original language model.

Therefore, it is necessary to find a method of extracting a visual context adjustment ability of the VLM independently of a questionable language modeling ability.

### 1.2 Visual Weight Extraction

A value for extracting a strength of visual context adjustment may be found in a state where a language modeling preference of the vision-language model (VLM) has been removed. To this end, the pointwise mutual information (PMI) (Church and Hanks, 1990) for measuring a correlation between two events (the text and the image in this case) is used. In each step, when a previous text context x<t is given, a PMI between an image context c and the next text token xt is calculated.

$$\begin{matrix}P M I ( {x}_{t} \vert c , {x}_{< t} ) = log \frac{{p}_{υ l} ( {x}_{t} , c \vert {x}_{< t} )}{{p}_{υ l} ( {x}_{t} \vert {x}_{< t} ) {p}_{υ l} ( c )} & \\ = log \frac{{p}_{υ l} ( {x}_{t} \vert c , {x}_{< t} )}{{p}_{υ l} ( {x}_{t} \vert {x}_{< t} )} & ( 3 )\end{matrix} \qquad ( 2 )$$

Formula (3) has a more manageable form in which the definition of Formula 2 is created again, and a numerator can be easily obtained as an image conditional likelihood of the VLM, but a denominator requires marginalization for the image context c, which requires excessive calculation to obtain an expected value for all possible images, and in order to solve this, it is possible to avoid a complex calculation by using the following three alternative methods.

In a marginal probability approximation method, a first approximation method is to train a separate text-only model using training data S of the VLM. However, when a large size of a dataset S is considered, an additional training burden is quite large, there is no guarantee that a newly trained model will accurately estimate a marginal probability, and there is a further difficulty due to the complexity of additional model training.

A second method is to use a sample mean of a pre-selected set of images as a substitute for an actual mean. Finally, a sufficient sample set can be created with only scores for one or two images.

A last method having a least calculation burden is used. Here, a sample set is a small set of images with little visual information, and in fact, two images are used. A black image cb and a white image cw are used.

Among them, a last method having a least calculation overhead is used. Here, a sample set is a small set of images with little visual information. In fact, two images are used. The images are the black image cb and the white image cw.

$${p}_{υ l} ( {x}_{t} \vert {x}_{< t} ) ∼ \frac{1}{2} {\sum }_{c ∈} \text{?} {p}_{υ l} ( {x}_{t} \vert {x}_{< t} , c ) \qquad ( 4 )$$

$$\text{?} \text{indicates text missing or illegible when filed}$$

This efficient alternative works well in practice and is used in all experiments. As a result, VLIS performs three forward passes of the VLM (one for the conditional likelihood and two for the marginal probability) and performs a forward pass of the text-only model once at each generation step.

### 1.3 Calculation of VLIS Score

The calculation starts with the token likelihood ptext(xt|c,x<t) of the text-only language model. In order to adjust the confidence in the determination of the text-only model, a language temperature t is introduced and a text-only distribution is adjusted to be smooth or not.

This serves to smoothly change a probability of the distribution to provide a wider variety of options or adjust a behavior of the model so that the model focuses more strongly on a specific selection.

$${\overline{p}}_{text} ( {x}_{t} \vert c , {x}_{< t} ) ∝ {p}_{text} ( {x}_{t} \vert c , {x}_{< t} ) \text{?} \qquad ( 5 )$$

$$\text{?} \text{indicates text missing or illegible when filed}$$

Then, the text likelihood is multiplied by the exponentiated PMI introduced in 1.2 so that the visual alignment is better aligned. VLIS determines the next text token xt through a score function f(xt) below.

$$\begin{matrix}f ( {x}_{t} ) = {\overline{p}}_{text} ( {x}_{t} \vert c , {x}_{< t} ) {e}^{PMI ( {x}_{t} , c \vert {x}_{< t} ) )} & \\ = {\overline{p}}_{text} ( {x}_{t} \vert c , {x}_{< t} ) \frac{{p}_{υ l} ( {x}_{t} \vert c , {x}_{< t} )}{{p}_{υ l} ( {x}_{t} \vert {x}_{< t} )} & ( 7 )\end{matrix} \qquad ( 6 )$$

According to Formula (7), VLIS performs importance sampling on a text-only model likelihood ptext. Importance sampling (Tokdar and Kass, 2010) is a Monte Carlo scheme, and is a method of estimating a value v(x) to be estimated from a nominal distribution p(x) through sampling from the importance distribution q(x). Here, the estimated value is a likelihood ptext(xt) of the text-only model, the nominal distribution is an image conditional likelihood pvl(xt|c) of the VLM, and the importance distribution is the marginal probability pvl(xt).

$$E [ f ( {x}_{t} ) : P ] ∼ {E}_{{x}_{t} ∼ q ( {x}_{t} )} [ υ ( {x}_{t} ) \frac{p ( {x}_{t} )}{q ( {x}_{t} )} ] \qquad ( 8 )$$

$$υ ( {x}_{t} ) := {\overline{p}}_{text} ( {x}_{t} \vert {x}_{< t} )$$

$$p ( {x}_{t} ) := p \text{?} ( {x}_{t} \vert c , {x}_{< t} )$$

$$q ( {x}_{t} ) := {p}_{υ l} ( {x}_{t} \vert {x}_{< t} )$$

$$\text{?} \text{indicates text missing or illegible when filed}$$

In terms of implementation, when the expected value is replaced with a single sample called a currently generated text, VLIS regards a current token candidate as being sampled in the marginal probability pvl(xt) of the VLM, and readjusts this by recalculating the importance with a conditional likelihood pvl(xt|c) of the VLM.

Fluency masking: A log visual weight of VLIS, PMI(xt,c|x<t), is a log-likelihood ratio, and since a range of values is not limited, a language generation process of the text-only model is excessively influenced in an extreme case where a value of a marginal probability pvl(xt|x<t) is very small, resulting in incomplete or abnormal text. To prevent such text degradation, a fluency mask is applied to an importance sampling score f(xt|x<t,c). That is, restrictions are applied so that only tokens whose probability of the text-only model is higher than a specific threshold value a are selected. In formulas below, the dependency on the context x<t,c is omitted for simplicity.

$$f \text{?} ( {x}_{t} ) = \{ \begin{matrix}f ( {x}_{t} ) , & if {x}_{t} ∈ {𝒱}_{top} \\ - inf , & otherwise\end{matrix} \qquad ( 9 )$$

$${𝒱}_{top} = \{ {x}_{t} \vert {p}_{text} ( {x}_{t} ) \geq α \} \qquad ( 10 )$$

$$\text{?} \text{indicates text missing or illegible when filed}$$

Intuitively, this mask filters out token candidates whose probability that the text-only model will regard the token candidates as next tokens is lower than a threshold α. In all experiments, a fluency threshold α is fixed to 0.001, and the same applies to a case in which an alternative structure is excluded. However, VLIS is not very sensitive to a specific value of the fluency threshold.

A token for maximizing a final score f˜(xt|c,x<t) is greedily selected and determined as a next token. When VLIS is combined with another decoding method such as beam search, this score replaces an original token likelihood as a score for each token.

### 2. Experiment: Factual Explanation

In experiments on weird information identification (21), commonsense understanding (22), and scientific reasoning (23), VLIS consistently outperforms an underlying VLM, and exhibits similar factual accuracy compared to strong baseline models.

### Experiment Setup

Two experimental setup are explored. In an experiment on a WHOOPS dataset, LLAVA (Liu et al., 2023) and Lynx (Zeng et al., 2023) are used as VLMs, and Vicuna 7B (Chiang et al., 2023) is used as a text-only model. In a visual question answering (VQA) experiment, BLIP2 OPT2.7B (Li et al., 2023b) and OPT IML Max 1.3B (Iyer et al., 2022) are used as baseline models. A model pair is intentionally selected to impose similar calculation requirements on both the VLM and the text-only model, thereby limiting an additional calculation burden of VLIS. In all the experiments, a basic VLM is used as a general baseline to evaluate the performance improvement due to VLIS. Further, to confirm a contribution of the PMI weight, a naïve ensemble was implemented, which is simply a multiplication of the token probabilities of the VLM and the text-only model.

### Evaluation Index

Closed-ended questions are evaluated through the accuracy of binary questions (WHOOPS) and multiple-alternative questions (ScienceQA). In OK-VQA and VQA v2, open-ended questions are evaluated using the VQA-specific evaluation index (Antol et al., 2015).

### 2.1 Weird Image Identification

WHOOPS (Bitton-Guetta et al., 2023) is a visual commonsense benchmark for evaluating an ability of a vision-language model (VLM) to understand images deviating from commonsense, and adopts weird image identification that is a subtask of a WHOOPS benchmark to evaluate an ability of the model to potentially distinguish the weird image.

### Approach and Baseline Model

According to an original paper (Bitton-Guetta et al., 2023), a pipelined scheme for transforming an original binary classification problem into an explanation generation problem is used. Specifically, the pipeline is a scheme in which a model first generates explanations-of-violation (EoV) for two given images, and then, the explanations-of-violation is input to a text-only classifier GPT-3 (Brown et al., 2020), which makes a binary decision about which image is weird, and VLIS is used to generate such EoV explanation.

As a baseline model for the pipeline scheme, an EoV explanation of a backbone VLM (LLAVA), an existing machine-generated caption, and ground-truth captions of a WHOOPS dataset are used. Further, BLIP-2 (both supervised learning and zero-shot scheme) is used as baseline models without a pipeline.

As a result, Table 1 and FIG. 3 show results of using LLAVA (Liu et al., 2023), that is, a vision-language model (VLM) with command tuning. Description of weirdness generated by VLIS showed similar performance to the ground-truth captions, and the ground-truth captions are obtained by performing a manual annotation process on details necessary to identify the weirdness. Further, this shows similar performance to a supervised learning baseline model, BLIP-2, despite being a zero-shot method. Interestingly, LLAVA itself does not outperform an existing machine-generated caption even when command tuning and a prompt are used.

TABLE 1
Results in the identification of weird images task of WHOOPS dataset
(Bitton-Guetta et al., 2023). Pipe represents further pipelining
with GPT3 and 0-shot denotes a zero-shot method. The best numbers
are bolded and the second best ones are underlined.

| Models | Pipe | 0-shot | Acc (%) |
|---|---|---|---|
| Chance | | | 50 |
| BLIP-2 | | ✓ | 50 |
| BLIP-2 | | | 73 |
| Model Caption | ✓ | ✓ | 59 |
| GT Caption | ✓ | ✓ | 74 |
| VLM (LLAVA) | ✓ | ✓ | 59 |
| VLM (Lynx) | ✓ | ✓ | 71 |
| Ours (LLAVA) | ✓ | ✓ | 73 |
| Ours (Lynx) | ✓ | ✓ | 80 |

### 2.2 Commonsense Understanding

Single-modal language models contain commonsense knowledge (Petroni et al., 2019; Davison et al., 2019; and Tamborrino et al., 2020). When VLIS can inherit this commonsense understanding ability, VLIS will outperform the basic VLM in tasks that require both commonsense and visual understanding. This likelihood is examined by using a commonsense-based VQA benchmark called OK-VQA (Marino et al., 2019). Further, confirmation is also made as to whether VLIS retains visual distinctiveness in VQAv2 (Goyal et al., 2017).

### Approach and Baseline Model

OK-VQA (Marino et al., 2019) is used as an example of a commonsense-based VQA problem, and VQAv2 (Goyal et al., 2017) is used as a VQA problem with high visual focus. Powerful VLM models such as FewVLM (Jin et al., 2022), Frozen (Tsimpoukelli et al., 2021), and VLKD (Dai et al., 2022) are used as baseline models to compare with VLIS.

### Commonsense Knowledge Results

In OK-VQA experimental results in Table 2, VLIS achieves meaningful performance improvement over a backbone VLM (BLIP-2). Further, a text-only backbone model (OPT-IML) and the naïve ensemble show much lower performance, which proves that VLIS does not simply mimic an output of the text-only model. Instead, VLIS adaptively fuses the commonsense understanding ability of the text-only model with a visual coordination ability of the VLM.

### Results of Retaining Visual Distinctiveness

In VQA where text-based inference is not required, VLIS should focus only on visual adjustment. It can be seen from results of the VQAv2 (Goyal et al., 2017) dataset summarized in the rightmost column of Table 2 that VLIS (our model) retains a VQA ability of the backbone VLM (BLIP-2) on such a VQA problem where textual bias has been intentionally removed. On the other hand, the naive ensemble gets left behind a text-only backbone (OPT-IML) and shows poor performance in the balance between the visual understanding and linguistic understanding.

TABLE 2
Results in the validation set of OKVQA (Marino et al.,
2019) and VQAv2 (Goyal et al., 2017). V denotes using
a VLM and L denotes using a unimodal language model.

| Models | V | L | OKVQA | VQAv2 |
|---|---|---|---|---|
| FewVLM | ✓ | | 16.5 | 47.7 |
| Frozen | ✓ | | 5.9 | 29.6 |
| VLKD | ✓ | | 13.3 | 42.6 |
| BLIP-2 | ✓ | | 31.7 | 53.5 |
| OPT-IML | | ✓ | 19.1 | 36.0 |
| Naïve | ✓ | ✓ | 26.6 | 34.6 |
| Ensemble | | | | |
| Ours | ✓ | ✓ | 34.2 | 53.6 |

### 2.3 Scientific Reasoning

ScienceQA (Lu et al., 2022a) is a benchmark for evaluating a multimodal scientific reasoning capability. Here, a goal of VLIS is to improve the accuracy of the answer when there is an image context (IMG), and maintain an answers of the text-only model under a condition of text (TXT) without a visual context or NO.

### Baseline Model

A zero-shot VLIS is compared with zero-shot baseline models. The zero-shot VLIS is included in the VLM (UnifiedQA (Khashabi et al., 2020)) and a text-only language model (GPT-3 Brown et al., 2020).

### Results

Table 3 shows experimental results on ScienceQA. In IMG segmentation, VLIS greatly outperforms a text-only model OPT-IML and a naive ensemble baseline model. Further, VLIS maintains the performance of the text-only backbone model in TXT and NO segmentation. Finally, it is shown that a basic VLM (BLIP-2) requires strong language understanding for scientific reasoning, and gets left behind by a large margin.

TABLE 3
Zero-shot results on ScienceQA test set (Lu et al., 2022a).
IMG denotes subset with image context, TXT the text context
subset, and NO the subset without any context.

| Models | IMG | TXT | NO | ALL |
|---|---|---|---|---|
| UnifiedQA_{Small} | 44.1 | 50.2 | 44.5 | 45.8 |
| UnifiedQA_{Base} | 48.1 | 53.1 | 46.7 | 48.5 |
| GPT-3 | 65.7 | 74.2 | 79.6 | 74.0 |
| BLIP-2 | 35.5 | 34.6 | 24.2 | 28.2 |
| OPT-IML | 45.4 | 52.2 | 49.8 | 49.0 |
| Naïve Ensemble | 45.9 | 53.6 | 49.7 | 49.7 |
| Ours | 49.3 | 53.1 | 49.1 | 50.2 |

### 3. Text Generation Experiments

The text-only language model shows two important capabilities in addition to factual knowledge:
The ability to follow a prompt instruction
The ability to generate fluent and varied text

It is proved that VLIS can extend these capabilities to a visual domain, and this is confirmed through the following tasks:
Contextualized Captioning (3.1)
Paragraph Captioning (3.2)
Visual Storytelling (3.3)

### Evaluation Indexes

A captioning benchmark uses automatic text evaluation indexes, including CIDEr (Vedantam et al., 2015), METEOR (Banerjee and Lavie, 2005), and Bleu-4 (Papineni et al., 2002).

In an open generation problem such as visual storytelling, various fluency index including 2-gram repetition, diversity, coherence, and MAUVE (Pillutla et al., 2021) are used.

CLIPScore (Hessel et al., 2021) is used as a visual strength evaluation index.

### 3.1 Contextualized Captioning

Concadia (Kreiss et al., 2022) is an image captioning dataset that provides additional paragraph context for Wikipedia articles, and provides two types of annotations:
Caption: Text considering the context of the article.
Description: Text that does not consider the context of the article.

### Approach and Baseline Model

According to an original evaluation scheme (Kreiss et al., 2022), we generate a single text and compare the single text with the ground-truth captions and the explanation. Examples of the baseline model include a supervised learning model (Kreiss et al., 2022) and a zero-shot scheme (Socratic Model, Zeng et al., 2022).

### Results

In Table 4, VLIS outperforms the Socratic Model (Zeng et al., 2022), and this is based on an implementation using a more powerful language model (GPT-3 175B, Brown et al., 2020). Interestingly, the basic VLM (BLIP-2) and VLIS generate completely different text styles. A VLIS caption is better according to a caption style and better reflects context of Wikipedia articles than the baseline models. On the other hand, the VLM better produces text of an explanation style. Nevertheless, the VLIS caption is similar to visually focused explanation and outperform other baseline models other than the VLM.

TABLE 4
Results on Concadia (Kreiss et al., 2022) test set.
Cap denotes caption and Desc description annotations.
We report CIDEr following the literature.

| Model | Zeroshot | Cap | Desc |
|---|---|---|---|
| Kreiss et al. | | 11.3 | 17.4 |
| Socratic Model | ✓ | 38.9 | 22.6 |
| BLIP-2 | ✓ | 20.0 | 30.6 |
| Naïve Ensemble | ✓ | 24.7 | 18.4 |
| Ours | ✓ | 44.1 | 28.3 |

### 3.2 Paragraph Captioning

Image Paragraph Captioning (Krause et al., 2017) is a task of generating a paragraph length caption that describe images in more detail, which is much more specific than a sentence-level caption.

### Approach and Baseline Model

In an initial experiment, neither the VLM nor the text-only model could follow a style of a correct answer annotation. Therefore, three in-context examples (3-shots) were provided to the model. This setup is still a much more challenging problem than baseline models based on fully supervised learning (the baseline models include Krause et al., 2017; Liang et al., 2017; SCST with repetition penalty, Melas-Kyriazi et al., 2018; HSGED, Yang et al., 2020; PaG-MEG SCST, Nguyen and Fernando, 2022).

### Results

As shown in Table 5, VLIS greatly improves the performance of the basic VLM (BLIP-2) to generate a paragraph caption at a similar level to supervised learning baseline models. VLIS exhibits a less text degradation phenomenon than basic VLM and minimizes visual illusions, unlike the naive ensemble.

TABLE 5
Results on the Paragraph Captioning (Krause et al., 2017)
test set. M denotes METEOR, C CIDEr, and B4 Bleu-4 scores.

| Model | Shots | M | C | B4 |
|---|---|---|---|---|
| Krause et al. | Full | 16.0 | 13.5 | 8.7 |
| Liang et al. | Full | 17.1 | 16.8 | 9.0 |
| SCST | Full | 13.6 | 13.8 | 5.9 |
| SCST_{Rep. Penalty} | Full | 17.9 | 30.6 | 10.6 |
| HSGED | Full | 18.3 | 36.0 | 11.3 |
| PaG-MEG-SCST | Full | 18.2 | 29.4 | 11.5 |
| BLIP-2 | 3 | 10.8 | 6.5 | 4.9 |
| OPT-IML | 3 | 9.5 | 2.5 | 2.2 |
| Naïve Ensemble | 3 | 9.8 | 6.0 | 3.6 |
| Ours | 3 | 14.6 | 14.8 | 6.4 |

### 4.3 Storytelling

Storytelling is an open-ended generation task, where VLIS should generate open text without a text degradation phenomenon while maintaining an image context.

### Approach and Baseline Model

Unlike previous experiments, a text-only model (Su et al., 2022b) is used and is a supervised learning model that is fine-tuned on a text-only ROCStories (Mostafazadeh et al., 2016) dataset. It can be safely assumed that this specialized text-only model better knows the language than the VLM in storytelling. MAGIC (Su et al., 2022a) with visual context applied thereto and a text-only contrastive search (Su and Collier, 2023) baseline model are included.

### Results

Results of open storytelling can be confirmed from Table 6. VLIS outperforms the contrastive search and the MAGIC in all evaluation index. Table 6 shows that, although the naive ensemble generated more diverse texts (as shown in rep-2 and div. index), a coherence score is very low and coherence of the story is degraded.

Finally, the basic VLM (BLIP-2) showed good correspondence between the image and the text with high CLIPScore, but had difficulty in generating coherent stories, from low performance in other indexes.

TABLE 6
Results in the ROCStories story generation dataset (Mostafazadeh et
al., 2016). rep-2 denotes 2-gram repetition, div. diversity, coh.
coherence, and CLIP, CLIPScore. Higher is better except for rep-2.

| Models | rep-2↓ | div.↑ | coh.↑ | Mauve↑ | CLIP.↑ |
|---|---|---|---|---|---|
| Cont. Search | 2.60 | 0.97 | 0.34 | 0.86 | 0.65 |
| MAGIC | 2.49 | 0.97 | 0.38 | 0.85 | 0.68 |
| BLIP-2 | 24.26 | 0.39 | 0.32 | 0.47 | 0.87 |
| Naïve Ensemble | 1.85 | 0.98 | 0.27 | 0.93 | 0.67 |
| Ours | 2.31 | 0.97 | 0.38 | 0.96 | 0.72 |

### 4. Qualitative Results

### Understanding of Commonsense

FIG. 4 shows zero-shot results in an OK-VQA (Marino et al., 2019) dataset. In (a) and (b), baseline models such as the basic VLM and the naive ensemble do not correctly understand the intent of the question (for example, dog species or native North American animals). The text-only model understands the question better and suggests a plausible answer (for example, pug or wolf), but cannot access a visual input and outputs a wrong answer as a result, whereas VLIS provides a better answer by appropriately combining the commonsense reasoning with the visual context.

(c) and (d) show failure cases. In (c), VLIS concludes that an answer should be a type of material according to a reasoning process of the text-only language model, but the VLM focuses on a foreground object (umbrella) in the image, causing VLIS to incorrectly answer a material (coincidentally, flammable paper) of the object. In (d), the text-only model generates an answer with no coherence (for example, “ocean”), and VLIS also inherits this misunderstanding and generates a wrong answer (“water”).

In conclusion, the VLIS well balances the visual distinctiveness of the VLM with the commonsense understanding of the text-only model, but also inherits the limitations of both modalities.

### Open-Ended Generation

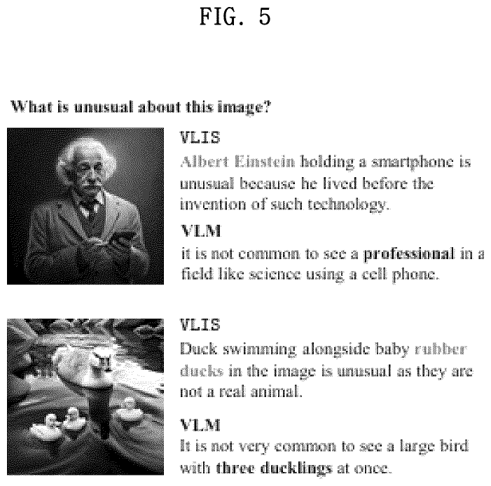

Finally, FIG. 5 shows an open-ended generation capability of VLIS, and VLIS should generate an output based on a variety of text prompts and images. Unlike the basic VLM, VLIS is more faithful to the prompts and generates a realistic self-introduction (for example, “hey, it's me”), a personal diary (for example, “today I went”), and a romantic message (for example, “here is a romantic message. answer:”). Further, VLIS performs a pun in association with an Apple laptop appearing in the image with a representation “apple of my eye.”

Although the preferred embodiments of the present invention have been described above, it will be understood by those skilled in the art that the present invention can be variously modified and changed without departing from the scope and spirit of the present invention described in the claims below.

### NATIONAL RESEARCH AND DEVELOPMENT PROJECT SUPPORTING THE PRESENT INVENTION

[Project Serial No] 2710006677
[Project No] RS-2020-II201361
[Name of department] Ministry of Science and ICT
[Task management (professional) institution name] Institute of Information and Communications Technology Planning and Evaluation
[Research Project name] Nurturing ICT and Broadcasting Innovation Talents (R&D)
[Research Task Name] Artificial Intelligence Graduate School Support Project (Yonsei University)
[Name of task performing organization] University Industry Foundation, Yonsei University
[Research period] 2024 Jan. 1˜2024 Dec. 31

### DETAILED DESCRIPTION OF MAIN ELEMENTS

100: Multimodal language processing device based on visual-language model
110: Response generation unit
120: PMI calculation unit
130: Importance sampling unit

What is claimed is:

1. A multimodal language processing device based on a visual-language model, comprising:
a response generation unit configured to receive a question including an image and text through a text-only language model and a vision-language model, and generate a text response and a multimodal response;
a PMI calculation unit configured to calculate pointwise mutual information (PMI) representing a correlation between the image and the text based on the multimodal response; and
an importance sampling unit configured to generate an importance weight based on the pointwise mutual information and adjust a token likelihood of the text response based on the importance weight to generate a final text response.

2. The multimodal language processing device based on a visual-language model of claim 1, wherein the response generation unit reflects a context of the image in the text through the vision-language model to generate the multimodal response.

3. The multimodal language processing device based on a visual-language model of claim 1, wherein the PMI calculation unit calculates mutual dependency between the image and the text as the pointwise mutual information to determine token importance of the text in the context of the image.

4. The multimodal language processing device based on a visual-language model of claim 3, wherein the PMI calculation unit calculates the mutual dependency as the pointwise mutual information based on a probability that a specific text will be generated when the image and a token of the text are given and a probability that the token of the text will be generated in a text context before the token of the text when only the text is given.

5. The multimodal language processing device based on a visual-language model of claim 1, wherein the importance sampling unit multiplies the token likelihood of the text response by the importance weight to select an important token from the text response.

6. The multimodal language processing device based on a visual-language model of claim 5, wherein the importance sampling unit selects the important token and reflects a visual context of the image in the final text response.

7. A visual-language model-based multimodal language processing method performed in a multimodal language processing device based on a visual-language model, the visual-language model-based multimodal language processing method comprising:
a response generation step of receiving a question including an image and text through a text-only language model and a vision-language model and generating a text response and a multimodal response to the question;
a PMI calculation step of calculating pointwise mutual information (PMI) representing a correlation between the image and the text based on the multimodal response; and
an importance sampling step of generating an importance weight based on the pointwise mutual information and adjusting a token likelihood of the text response based on the importance weight to generate a final text response.

8. The visual-language model-based multimodal language processing method of claim 7, wherein the response generation step includes reflecting a context of the image in the text through the vision-language model to generate the multimodal response.

9. The visual-language model-based multimodal language processing method of claim 7, wherein the PMI calculation step includes calculating mutual dependency between the image and the text as the pointwise mutual information to determine token importance of the text in the context of the image.

10. The visual-language model-based multimodal language processing method of claim 9, wherein the PMI calculation unit calculates the mutual dependency as the pointwise mutual information based on a probability that a specific text will be generated when the image and a token of the text are given and a probability that the token of the text will be generated in a text context before the token of the text when only the text is given.

11. The visual-language model-based multimodal language processing method of claim 7, wherein the importance sampling step includes multiplying the token likelihood of the text response by the importance weight to select an important token from the text response.

12. The visual-language model-based multimodal language processing method of claim 11, wherein the importance sampling step further includes selecting the important token and reflects the visual context of the image in the final text response.
